(19) United States
(12) Patent Application Publication
(10) Pub. No.: US 2009/0315669 A1
(43) Pub. Date: Dec. 24, 2009

(54) SAFETY SYSTEM

(76) Inventors: Robert Bruce Lang, Mulgrave (AU); Vincent Charles Sharp, Caulfield South (AU); Roger Graham Owens, Ashburton (AU)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 12/307,138

(22) PCT Filed: Jul. 4, 2007
(86) PCT No.: PCT/AU2007/000930

§ 371 Date: Apr. 17, 2009

(30) Foreign Application Priority Data
Jul. 4, 2006 (AU) 2006903603

(51) Int. Cl. G05B 23/02; G08B 17/10

(52) U.S. Cl. 340/3.1; 340/628

(57) ABSTRACT

A safety system for alerting occupants of a fire or smoke occurring within a building in which the safety system includes a smoke detector associated with an electric door release mechanism of a locked door that is energised to unlock the door automatically in response to receiving a signal from a control unit which in turn receives a signal from a smoke detector when fire or smoke is detected so that the door is automatically opened by the electric door release mechanism being released by movement of an electrically operated striker plate to allow occupants trapped within the building to escape from the burning building, whilst allowing access to the building for emergency rescue personnel.

### FIELD OF THE INVENTION

The present invention relates to the automatic unlocking and release of a locked barrier in response to the activation of a detector for sensing a non normal event.

In particular, the present invention relates to a safety system which operates to release automatically a locked barrier of a building in response to the detection of an abnormal event such as fire and/or smoke to release the barrier to allow it to open thereby permitting occupants of the building to escape from the fire to safety through the open barrier.

In one embodiment, the present invention relates to a safety system incorporating a smoke detector associated with an electric door release mechanism of a locked door that is energised to unlock the door in response to the detection of fire or smoke by the smoke detector so that the door is automatically opened to allow occupants trapped within the building to escape from the burning building or similar thereby preserving their life. Additionally, the present invention relates to methods of operating the safety system to automatically release the locked door in case of fire.

The present invention finds particular application in electrically releasing a deadlocked door provided with a deadlock in response to the detection of fire or smoke or other abnormal occurrence within a building by a suitable detector by moving the strike plate to release the deadlock bolt of the deadlock from being held captive in the strike plate thereby allowing the door to open so as to allow safe passage of occupants through the doorway thereby facilitating their escape from the burning building or similar.

Although the present invention will be described with particular reference to one form of the safety system, it is to be noted that the scope of the present invention is not restricted to the described embodiment but rather the scope of the present invention is broader so as to encompass other forms and variations of the safety system including other forms and variations of each of the components comprising the safety system and to the use of the various forms of the safety system in applications and uses other than the particular application or use described, and in response to other abnormal events or occurrences than described.

### BACKGROUND OF THE INVENTION

Fire is an ever present potential hazard of buildings occupied by humans and animals, particularly during the night when the occupants are asleep. In the past, attempts have been provided to alert occupants to fire occurring within the dwelling in order to allow sufficient time for the occupants to escape before the fire engulfs the building. One such attempt has been to include smoke detectors within the dwelling. In Australia at present, residential properties, hotel and motel rooms, apartments and commercial premises must be equipped with one or more of the various types of working smoke alarms which are currently available. Further, any new building being constructed must incorporate a mains powered smoke alarm whilst existing buildings are required to install retrospectively smoke alarms, such as for example, existing buildings are retro-fitted with simple to install, low cost battery operated smoke alarms. One example of the low cost units are the smoke detectors available for purchase from local hardware shops for do-it yourself installation by the occupants of the building. The introduction of low cost easily installed smoke detectors into residential properties has proven to be a significant improvement to household safety.

In the event of a fire or in the event of a room filling with excess smoke, the alarm is activated to emit a loud continuous warning sound, such as for example, a high pitched noise designed to alert occupants of the dwelling to the presence of the fire when smoke is detected.

On hearing the alarm sound, occupants are usually aroused from sleep and make their way as best they are able to a suitable exit from the building such as for example, through a doorway or similar, provided the door is open or readily openable, particularly from the inside.

Between the retreating occupants and safety, there is very often a barrier usually in the form of a door which requires opening to allow passage from the building through the doorway to the outside and hence to safety. In many cases, the door is a front door or rear door which is locked, often deadlocked, during the night for security purposes.

Additionally, the barrier could be a secured door, such as for example, a door which may be deadlocked requiring a key to release the lock to allow the door to open. Further, many doorways, particularly the front door in addition to the deadlocked door are provided with security screen doors protecting the main door in which the screen doors are usually deadlocked for security reasons particularly when the occupants are inside the building and during the night for added security since the function and purpose of the security doors is to provide a security barrier against unwanted intruders from outside. Security doors are usually installed to protect each doorway and generally require a key for their release before they can be opened.

However, locked security doors and deadlocked main doors present a serious problem to retreating people during a fire by hindering their escape from the burning building since locked or deadlocked doors require a key to unlock them, particularly as the occupants could be stumbling about half asleep or confused. Often, the key is stored remote from the door, such as for example, in a convenient location in the kitchen or in some other part of the house away from the door. In the event of a fire, there is both a danger from the fire itself in the form of heat and from the large volumes of toxic hot smoke which are generated during combustion as the fire develops, both of which hinder or prevent an orderly retreat from the building and prevent speedy passage through the doorways, particularly if the door is deadlocked and the key to unlock the deadlock is not close at hand or readily locatable. In many instances, the bodies of occupants of a building are found trapped behind deadlocked doors. Such a situation can arise in night clubs and other entertainment venues or the like through escaping patrons not being able to quickly open the locked doors to affect an escape. In other circumstances, bodies have been located in a position commensurate with unsuccessfully searching for keys to unlock the deadlock before being overcome with smoke.

Therefore, there is a need for a safety system which allows a barrier, particularly a deadlocked door or other security installation or secured item, to be released when a fire is detected in a dwelling so that the barrier can be opened readily to allow occupants of the building to escape from the burning building without having to locate a key to unlock the door before escape can be effected thereby preventing loss of life by being trapped within the burning building.

Accordingly, it is one aim of the present invention to provide a safety system in which a locked barrier such as a door, can be unlocked automatically in response to the detection of an abnormal event such as fire or smoke being detected within the building thereby obviating the need to locate a key and to insert the key into the lock to unlock the door to release the door before occupants can escape from the building through the doorway.

It is another aim of the present invention to provide a release mechanism for a barrier such as a door which uses the power supply of a detector to effect operation of the release mechanism to open a door or similar when the detector senses an abnormal condition, such as a fire, thereby avoiding the problems caused by interrupted power to the release mechanism.

It is to be noted that not all embodiments of the present invention satisfy all of the aims of the invention. Some embodiments will satisfy one aim whilst other embodiments will satisfy another aim. Some embodiments may satisfy two or more aims.

### SUMMARY OF THE INVENTION

According to one aspect of the present invention, there is provided a safety system capable of being used to release a barrier thereby allowing operation of the barrier in the event of an abnormal condition occurring, said safety device comprising an abnormal condition detector including a sensor for detecting the occurrence of the abnormal event and a signal producing device for generating a detection signal when the abnormal event is sensed, and a control unit, for receiving the detection signal from the detector and conveying an operational signal to a release sub-assembly for releasing the barrier such that in operation, the operational signal from the control unit activates the release sub-assembly to release the barrier thereby allowing the barrier to be opened.

According to another aspect of the present invention, there is provided a method of releasing a barrier in response to the detection of an abnormal event thereby allowing the barrier to open comprising the steps of generating a detection signal from an abnormal condition detector having a sensor for detecting the abnormal event when the detector senses the abnormal event, forwarding the detection signal to a control unit, forwarding an operational signal from the control unit to a release sub-assembly for releasing the barrier, such that the barrier is released in response to the detection of the abnormal event by the abnormal condition detector thereby allowing the barrier to be released.

According to another aspect of the present invention, there is provided a safety system capable of releasing a locked door allowing the door to open in the event of a fire or other abnormal event occurring, said safety system comprising a fire and/or smoke detector including a sensor for detecting heat and/or smoke and a signal producing device for producing a detection signal in accordance with the sensing of the fire and/or smoke by the detector, a control unit for receiving the detection signal and producing an operational signal for forwarding to the release sub-assembly for releasing the door such that when the fire and/or smoke occurs, the detector senses the occurrence of the fire and/or smoke and generates the detection signal in response to which the control unit is activated to forward the operational signal to energise the door release sub-assembly to open the door thereby resulting in opening of the door thereby allowing occupants of the building in which the safety system is located to escape from the building through the open door.

### BRIEF DESCRIPTION OF THE INVENTION

Typically, the safety system and method of using the safety system of the present invention is designed to appeal to householders concerned about a manner of escape in a fire situation when egress from a residence may otherwise be barred by a locked door such as for example a deadlocked door, locked security door or the like.

Typically, the safety system and method of the present invention is applicable to private residences, apartments, units, hotels, motels, boarding houses, nursing homes, nightclubs, entertainment venues, sporting arenas, commercial properties in general, stables, zoos, animal enclosures or the like where people or animals congregate, live, work, shelter, or are housed or the like.

Typically, the detector is a smoke detector, typically a mains powered smoke detector, a battery operated smoke detector or the like having its own power source or an external power source.

Typically, the detector is a photoelectric smoke detector, an ionisation type detector, a combination carbon monoxide and smoke detector, carbon monoxide detector, near infra red detector, hazard detector, oxygen deficiency detector or the like or combinations of two or more.

Typically, the sensor of the detector is a sensor for detecting smoke, heat, fire, light, radiation, including continuous, intermittent, flickering or pulsating radiation in the form of heat, light or the like.

Typically, the detector is provided with an alarm. More typically, the smoke detector or fire detector is provided with an audible or visual alarm or combination of audible and visual alarm.

Typically, the alarm operates continuously, intermittently, periodically or in any other suitable manner. More typically, the alarm is a warning siren or similar or is a light, including a flashing light or is provided with an indicator indicating that a detection signal has been generated by the detector either visually, audibly or both.

Typically, there is a single detector or two or more detectors including a plurality of detectors. The multitude or plurality of detectors, if present, are interconnected together, networked or arranged in groups or arrays.

Typically, the battery operated type smoke detector is a FIRETRONICS Model FID-HRLY whereas the mains powered version either direct mains power or through low voltage using a transformer, plug-pack, charger or the like, is typically FIRETRONICS model FD-N.

More typically, the smoke detector or smoke alarm is provided with relay contacts for electrical connection within the detector or alarm of the transmitter.

Typically, the smoke detector or alarm is provided with an under-voltage detection for use with non-mains powered versions to provide an indication, such as for example, a visual indication of the low voltage state of the battery.

Typically, the power supply of the detector, preferably the battery power, is used to operate the release subassembly or mechanism to guard against disruption of power, such as mains power, to the subassembly or mechanism.

Typically, the transmitter is or can be modified from an Arlec model DC170 Portable Wireless transmitter of the type that is used as an electronics door chime. More typically, the transmission from the transmitter of the smoke detector is broadcast as a coded radio signal operating in one of the designated Industrial, Scientific, Medical (ISM) frequency bands when the fire/smoke is detected, preferably in the band of from about 433.050 to about 434.90 MH_{z}, and more preferably at 433.92 MH_{z} over a range of up to about 10 metres or the like. More typically, the code broadcast by the transmitter is a rolling code.

Alternatively, other frequencies or other operating protocols can be used, such as for example, other widely used commercial protocols including “Blue tooth” or the like. Additionally, the frequencies used can be in a much higher band, such as for example, at or about 2.4 GH_{z} or the like.

Typically, the digital code broadcast by the smoke detector persists for at least about 15 seconds for each activation, repeating the code about at least 3 times per second. More typically, power to the broadcast transmitter is applied only during an alarm condition.

Typically, the safety system includes a receiver for receiving the detection signal transmitted or produced by the abnormal condition detector. More typically, the receiver is associated with the control unit. Even more typically, the detector is a transmitter for generating and transmitting a signal to the receiver. Even more typically, the receiver is electrically connected to the control unit to relay the detection signal to the control unit. Alternatively, the detector is hard wired or electrically connected to the control unit or to the receiver. Even more typically, the detector is provided with a transmitter for producing a wireless transmission for being received by the receiver.

Typically, the receiver is provided with an audible and/or visual indicating device that activates to signify that a validly coded broadcast has been received. More typically, the broadcast receiver operates over a DC voltage range of about 8.5 to 13.0 volts.

More typically, the broadcast receiver uniquely decodes the signal from the smoke alarm only. Even more typically, the broadcast receiver output is in the order of about battery volts (+0, −1 volt) when no valid broadcast is uniquely coded and falls to about ground voltage for a period of 10 seconds ±1 second when a valid broadcast is uniquely decoded (Alarm State Active Signal).

Typically, the sensitivity of the broadcast receiver is such that with direct line of sight the smoke detector broadcast in the alarm state can be detected up to a range of at least 10 metres or more.

Typically, the smoke detector transmits either using a hard wired connection or using a transmitted signal, such as a radio frequency signal to a security panel. Typically, the security panel transmits either by being electrically connected with wire or through a radio frequency transmission to the door release module or subassembly to release the door. Using this embodiment security associated with the system is increased, such as for example, by only releasing the door if the alarm is disarmed or in a monitor mode, such as for example, when the dwelling is occupied by the occupants and not releasing the door if the alarm panel is armed, such as when the occupants are not in the dwelling.

More typically, the security panel is the control unit or is used in association with the control unit. In one embodiment, the security panel is provided with a transmitter.

Typically, there is a single control unit to which all of the detectors are connected such that the detection of a single detector automatically releases a range of release sub-assemblies to open a range of doors, windows or the like.

Typically, the control unit is a switching arrangement. More typically, the switching arrangement is a switch, particularly an electronic switch, which is connected to the door sub-assembly release.

Typically, the control unit or switch produces an operational signal. Typically, the detection signal and/or operational signal forwarded to the release sub-assembly is continuous, intermittent, periodic, pulsed, sequential, arranged in bursts, including multiple bursts, repeatable multiple bursts, or the like.

Typically, the switch operates normally with a battery supply ranging from about 15 volts DC to about 8 volts DC.

More typically, the switch is activated only once by the presence of the “alarm state active” signal or detectional signal from the receiver.

Typically, the switch output provides at least about 10 pulses at a nominal 10 H_{z} pulse repetition rate.

More typically, the barrier is a door, gate, window, or other more or less temporarily closed or selectively closed opening or passageway. Even more typically, the door, gate, window or the like is hingedly connected to a window frame, door frame or similar supporting structure. More typically, the door is a main door, security door, screen door provided with a lock such as a deadlock, key pad operated lock, combination lock or similar. More typically, the lock for releasably locking the door is a double cylinder deadlock type, which can be deadlocked from both side of the door. More typically, the door can be an inwards or outwards opening door.

Typically, the release sub-assembly is operable between a locked condition and a release condition. More typically, the release sub-assembly is instantaneously operable or instantaneously activated to move from a locked or secured condition to a released or open condition. Even more typically, the release sub-assembly is an electric door release including an instantaneous electric door release which instantaneously moves to a release position to unlock the barrier allowing the door to open when it receives a corresponding signal from the control unit.

Typically, the release sub-assembly or release mechanism is an electric door release, more typically, an electronically operated door striker plate or door strike. Even more typically, the electrically operated door striker or striker plate is made by DORCAS, typically a DORCAS Model Aa. This type of door strike or plate moves to the release condition by pivoting or rotating about an axis away from the door thus releasing the bolt or dead bolt of the lock so that the door can be opened whilst the bolt is in the extended position. After the door opens, the electric strike plate can return to its normal at rest position.

Preferably, the striker plate is released to allow the barrier to open by a single burst of energy since the single burst of energy toggles the barrier to an open position. More preferably, the door release remains open after being toggled to the open position. Even more preferably, the door release sub-assembly is reset after the door opens, thereby providing an additional safety feature since the release cannot move to the secure position until after the door is opened.

Typically, the electric door release operates at a voltage of at least about 8.0 volts.

Typically, the safety system of the present invention automatically releases deadlocks by moving the electrically operated strike plate from the locked position to the release position thereby releasing the door for movement away from the door frame in the event that the smoke detector enters an alarm state by sensing the presence of smoke and/or heat. More typically, the electric door release moves to the release state when a momentary pulse of specified current at or above a specified minimum voltage is applied or directed to the electrically operable door release striker plate to open the door.

In some embodiments, after a period of time, the electric door release, such as the electric strike plate, returns to the “latched” or locked state after the deadlock and/or deadbolt is disengaged from the door release mechanism i.e. after the door opens, so as to prevent the door relocking during the abnormal event and inadvertently trapping other occupants. More typically, the use of the electric type strike or strike plate requires only a momentary application of power for it to toggle to the release state and to remain in the release state until the door is opened, thereby operating as the release mechanism or sub-assembly, particularly for double cylinder deadlocked doors.

Typically, once the electric strike plate is released by receiving a single pulse or multiple bursts of energy, the electric strike plate does not reset to the “locked” state even when all of the available power, including the battery or mains power, is interrupted. More typically, once released, the electric strike plate will remain in the released state for an unlimited amount of time, i.e. almost permanently, until the door or barrier is opened, insuring that occupants who are delayed from arriving at the door will not be trapped by the lock either automatically or inadvertently resetting after a period of time has elapsed or resetting once power to the electric strike is interrupted. Even more typically, once released, the electric strike plate is reset, i.e. returns to the secured or locked position only by the door opening or the deadbolt being removed from engagement with the electric strike plate.

Typically, the electric strike plate lock is adapted for use with a double cylinder deadlock type since this type of lock can be deadlocked from both sides of the door.

Typically, the electric strike plate has a range of movements between the locked position and the release position to accommodate the longer length of the deadbolt of the double cylinder deadlock so that when in the release position the deadbolt remains clear of the strike plate.

Typically, the electronic components of the safety system of the present invention are selected to satisfy the temperature range requirement of from 0 to 55° C. and still remain reliable and operational.

Typically, there is provided a remote control for activating the strike plate release in some circumstances as warranted.

Typically, the present invention uses micro controllers, more typically, “Microchip” PIC's. More typically, the PIC's consume very low current. Even more typically, the microchip is a PIC 16F628A.

Typically, an anti-spoofing code is incorporated in the PIC controlling the receiver. The anti-spoofing code is designed to detect attempts to crack the security coding system that could otherwise result in the protected door being released by undesirable elements, and causing a security breach to the structure. Typically, the data structure and data rate of the code transmitted will also be non-standard to reduce the possibility of commercial “code grabbers” emulating the transmitter used in the smoke alarm.

### DESCRIPTION OF THE DRAWINGS

The present invention will now be described by way of a non limiting example with reference to the accompanying drawings in which:

FIG. 1 is a schematic block diagram of one arrangement of one form of the safety system of the present invention being a form in which the detector is provided with a transmitter and receiver.

FIG. 2 is a circuit diagram of one embodiment of the wireless transmitter form of the smoke detector used in one form of the safety system of the present invention.

FIG. 3 is a circuit diagram of another embodiment of the safety system of the present invention being a wireless received form of the smoke detector.

FIG. 4 is a circuit diagram of another embodiment of the safety system of the present invention.

FIG. 5 is a circuit diagram of another form of the safety system of the present invention.

FIG. 6 is a circuit diagram of another form of the safety system of the present invention.

### DETAILED DESCRIPTION OF THE INVENTION

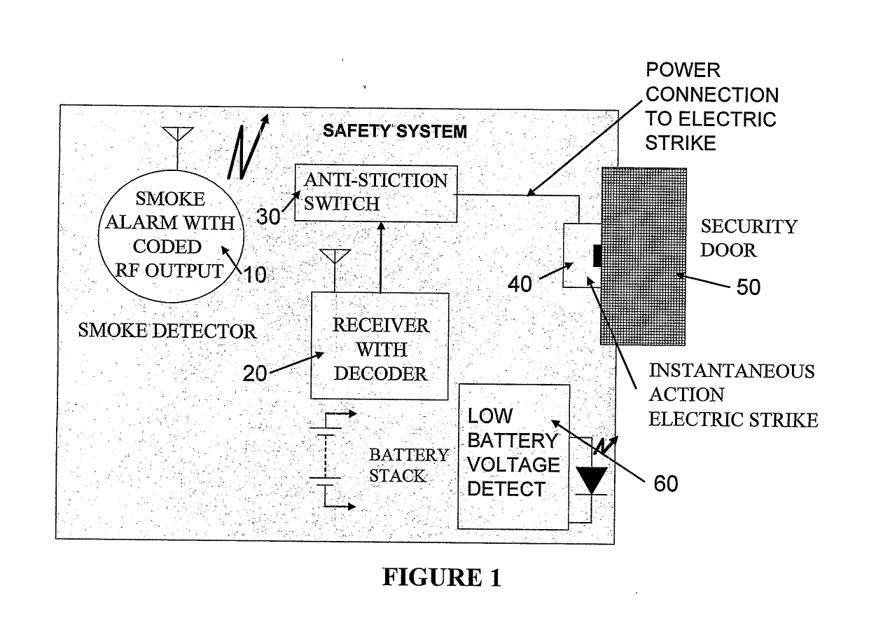

In FIG. 1, there is shown schematically one arrangement of the safety system of the present invention, generally denoted as 2, comprising a smoke detector 10 having a transmitter for broadcasting a coded detection signal, a receiver 20 tuned to receive the coded detection signal, a control unit in the form of a switch 30 to provide an operational signal to a release subassembly in the form of an instantaneous action electric door release 40 connected to a secured item in the form of a locked door 50 in which power to the detector 40, and to the entire safety system 2, is provided by battery 60.

It is to be noted that other embodiments of the safety system are possible such as for example the detector being hardwired to the control unit for switching power to the electric door release, and to having auxiliary power, such as for example, provided as an external power source.

In one form the smoke detector 10 is provided with a sensor, such as for example, an ionisation sensor for detecting the presence of smoke particles in the air. The detector 10 is also provided with an alarm for providing a warning in response to the sensor sensing smoke particles produced in an amount above a threshold amount by combustion when there is a fire. Typically, the alarm is either a continuous siren sound, optionally combined with a visible warning such as a flashing light or the like. Additionally, detector 10 is provided with a signal generator for generating a coded radio frequency (RF) signal as an output from the detector. In one form which is the wireless version, the smoke detector is equipped with a security coded radio transmitter for generating the detection signal in the form of the RF transmission which is transmitted or broadcast from the detector in response to the sensor sensing smoke or fire.

In another embodiment, which is the hard wired option, the output from detector 10 is an electrical connection with the control unit in the form of switch 30 for conveying the detection signal produced by the detector to the switch and the switch in turn providing an operational signal to open the door 50.

In the embodiment having the RF transmitter, i.e the wireless form, there is a receiver 20 tuned to receive the coded transmitted detection signal from the transmitter of the detector. The receiver is either separate from the switch 30 or is integral with the switch 30 or in any combination. The receiver 20 is provided with a decoder and in use listens for validly coded broadcasts from the smoke detector 10 so as to activate the switch in response to the detection of the detection signal produced by the detector when a fire is sensed. In the hardwired embodiment the receiver can be omitted as the detector is connected directly to the switch.

The switch which is an electronic switch is in electric connection to the electrically operated strike plate 40 or similar of the door release subassembly so that operational signal produced by the switch in response to receiving the detection signal can be sent to the release to open the door.

In one embodiment the switch is an anti STICTION switch which is an anti-stick switch (i.e. is an anti STIcky friCTION switch) which overcomes the binding force of friction between sliding or moving membrane of the electric strike forming the door release subassembly.

The detector is connected directly to the door release subassembly directly through an electronic switch that is “off” in the absence of the electrical signal from the detector, and is “on” for a period that ensures activation of the striker plate release following detection of the detector's electrical signal.

In one embodiment the electric door release is provided with a visual indication, such as for example, a light or similar indicating the door latch location.

In one embodiment, a doorway is provided comprising a moveable door 50 hingedly connected to a fixed door frame by suitable hinges on one side of the door frame. The door can open inwardly or outwardly. The door locking mechanism comprising a strike plate and latching bolt or similar is provided on the side of the door opposite to the side containing the hinges. The locking mechanism of the door includes a lock, particularly a deadlock, and an electric strike which can be released automatically when energised by receiving a signal from the switch. The electric strike moves between a locked configuration and a release configuration to allow the locked door to open without the lock or the door releasing. It is to be noted that the switch is electrically connected to the electric strike so as to send an operating signal to the strike in response to receiving the detection signal. Normally, the electric strike is in the secured position so that the latch bolt of the deadlock has to be operated to be withdrawn from the strike in order to open the door. However, in use of the present invention when the electric strike receives the operating signal from the switch, the strike moves from the secured position to the release position allowing the door to open even when the latch bolt of the deadlock is in the locked fully extended position. Thus, as soon as a fire is detected, the electric strike operates automatically to release the door allowing it to be quickly and easily opened thereby providing a ready escape route for the occupants of the dwelling on fire. It is to be noted that the instantaneous action electric door release which releases the door dead latch remains released until the door is opened.

The specific components of the safety system of the present invention will now be described in more detail.

Transmitter for Producing a Detection Signal

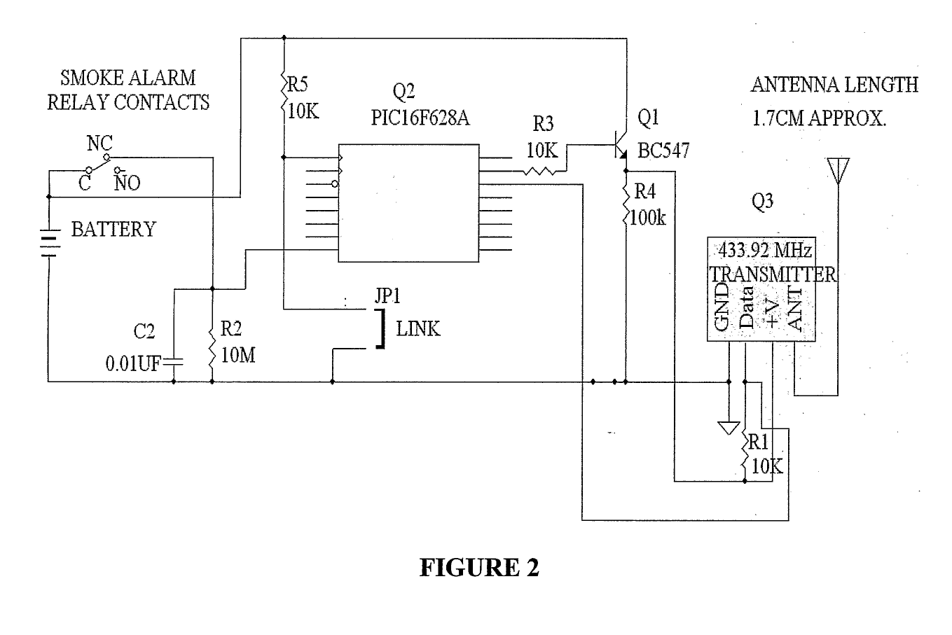

One embodiment of the transmitter incorporated into the detector for producing the detection signal for transmitting to the receiver (where provided) will now be described with particular reference to FIG. 2.

A circuit for a code hopping transmitter interfaced to the Smoke Alarm equipped with relay contacts is illustrated in FIG. 2. An explanation of circuit operation follows:
U1 is an ICM 7555 timer configured for monostable operation. Upon detection of a negative voltage transition on the TRIGger input, the output at Q transitions from low to high for approximately 15 seconds. Timing of the transition period is set by components C1 and R1. This function is required to provide continuous transmission of the detection signal for a minimum of 15 seconds, no matter how long the Smoke Alarm remains in the alarm state.
Triggering of the monostable occurs when the Smoke Alarm contacts (or electronic equivalent) change over, that is, when the Normally Closed contact becomes open circuit.
With the monostable output in the inactive state, bipolar transistor Q1 is held in the Off state, and battery voltage from the Smoke Alarm's battery is not presented to the following components U2 and U3 (note that U2 could remain permanently connected to the battery supply as standby current drain is only 1 microampere maximum in the standby state).
U2 is a KeyLog model HCS201 code hopping encoder. This device will encode up to three switch inputs for a maximum of seven key combinations. The system employs only one of the possible three coding inputs. U2 is powered on when the monostable (U1) is activated by the smoke alarm relay contacts changing state, and input SO is raised high to trigger the code burst for the period of operation of U1. The output of U2 connects directly to the Data input of the transmitter. The data rate is set to 2500 BPS when the Baud Rate Select Bit (BRS) set to 0. A minimum of 4 repetitions of the 66 bit code word are sent when the MTX4 bit is cleared. The code word continues to be repeated while the button remains pressed (in this case, an active high on the S0 pin).
U3 is a transmitter module designed to operate in the required ISM band of 433.92 MHz. The transmitter also remains unpowered until such time as the Smoke Alarm relay contacts change state and excite the monostable. The module transmits the data from U2 using Amplitude Shift Keying (ASK) as the modulation technique.
For optimum operation, an antenna tuned to the carrier frequency must be connected to the ANTenna port of U3. In the simplest case, this may be a 170 mm length of multi strand hookup wire. An antenna etched onto the PCB would be preferred, as this will minimise production costs.

Receiver for Receiving the Detection Signal.

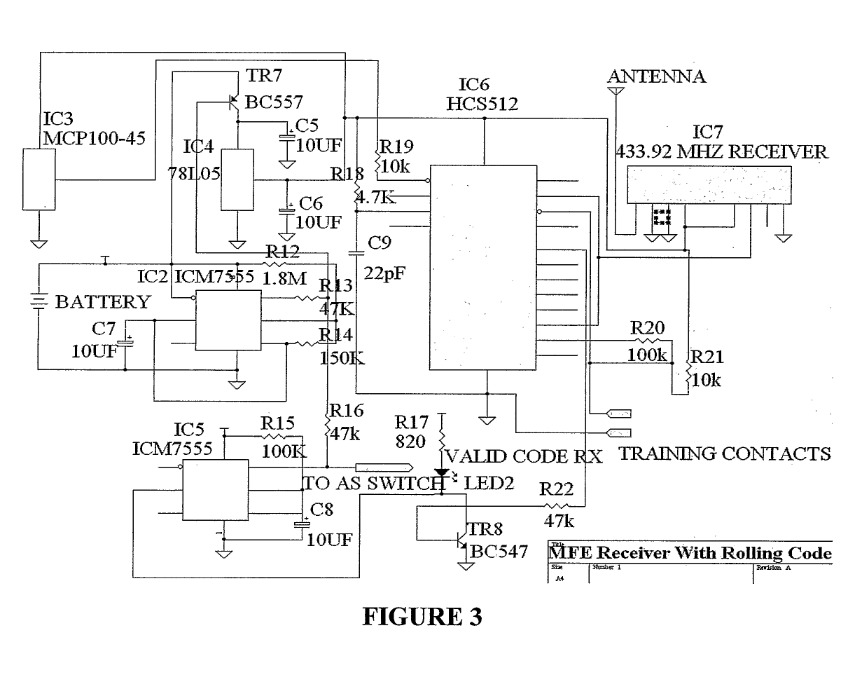

One embodiment of the receiver for receiving the detection signal will now be described with particular reference to FIG. 3.

One embodiment of a circuit for a code hopping receiver is illustrated in FIG. 3. Commercially available, low cost receiver modules are employed, along with a KeyLoq decoder and required associated circuits. A detailed description of circuit operation follows:
Power to the code hopping decoder and 433.92 MHz receiver circuit is applied periodically in accordance with the average current consumption requirements. The actual period chosen will depend on the choice of production quality receiver module. The on and off times are set by timer IC2, and the values of resistors R13, R14 and capacitor C7. For the values shown, an on time of 1 second and off time of 13.8 seconds is exhibited.
Other times can be calculated using the following formulae:

f=1.44/(R13+R14)*C7, where f is the inverse of the sum of the on plus off times.

D=(R13+R14)/(R13+2*R14), where D is the Duty Cycle (ratio of on to off time.
Battery voltage is regulated to the 5 volts required by the receiver module by IC4, a voltage regulator which provides 5 volts output over the input voltage range of 20 to 7 volts.
Transistor TR7 is switched on during the low time of IC2, and applies battery power to voltage regulator IC4 (78L05), which in turn supplies stable +5 volts to the rolling code decoder (IC6) and the RF receiver module (IC7).
Integrated Circuit IC3 warns the rolling code decoder of impending loss of regulated power, and is required by IC6.
IC7 is the 433.92 MHz RF receiver module, and performs all the required functions of converting RF broadcasts to digital pulses. Received pulses are presented to the rolling code decoder IC6 to identify valid activation codes. RF sensitivity of commercially available modules are typically—106 dBm.
When IC6 decodes a valid code, output S0 pulses to a logic high. This logic level is inverted by transistor TR8 to provide the required negative transition to IC5. While TR8 is in the “low” state, LED 2 illuminates to provide a visible indication that a valid code has been received.
IC5 is configured as a monostable circuit, and maintains a logic high until triggered, then presents a low to the input to the anti-stiction switch for the period of about 10 seconds and 1 second. This period is set by R15 and C8 in accordance with Tlow=1.1×R15×C8.

Note that either in production or during installation, the receiver should be trained to the transmitter in the Smoke Detector. To this end, contacts on a pin header should be provided on the PCB to activate training mode.

Anti Stiction Switch

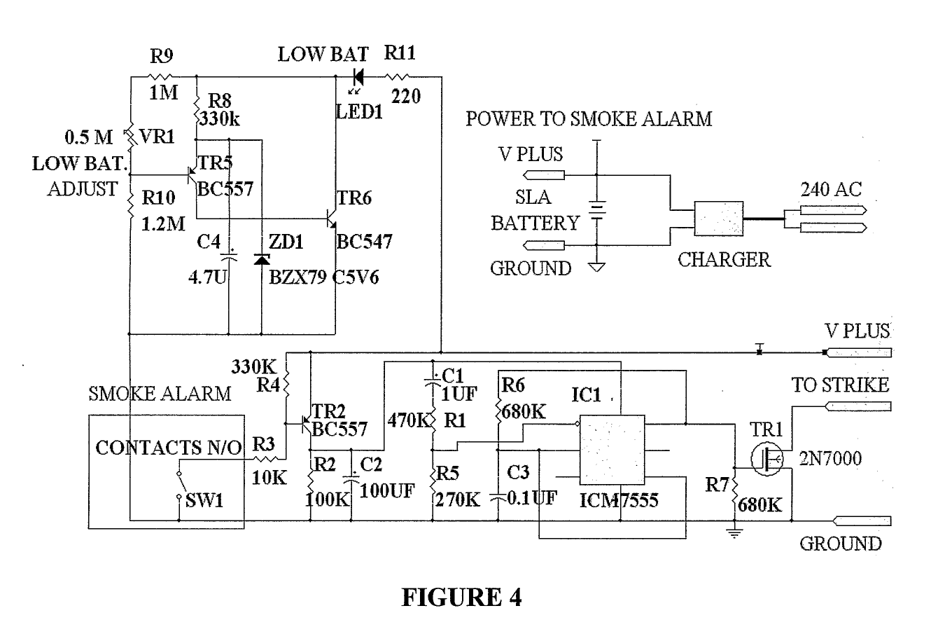

One embodiment of the anti stiction switch for conveying the operation signal to the electric strike will now be described with particular reference to FIG. 4.

FIG. 4 contains the circuit diagram for the complete wired version of one embodiment of the safety system of the present invention, including the Anti Stiction Switch. Also included in this diagram is a low battery monitor. This diagram assumes the Smoke Alarm is equipped with relay contacts that close in response to an alarm event.

Anti Stiction Circuit Operational Description:

The function of the Anti Stiction Switch is to reliably operate the instantaneous electric door release. This is achieved by applying a burst of current pulses of the specified Pulse Repetition Rate (PRR) for the specified duration. A detailed description of circuit operation follows:
Integrated circuit IC1 (LM 7555 CMOS timer) is powered up ready to drive the switching elements TR4 and TR1 by the voltage at C2's positive terminal.
C2 charges rapidly to near the battery voltage when a smoke detection event triggers the smoke alarm and closes the normally open relay contacts, thus switching transistor TR2 to the “On” state. If the relay contacts release prior to the conclusion of the operation of IC1, then the charge stored on C2 maintains power to IC1 for the required period.
IC1 is configured as an astable multivibrator, held off from operating until the voltage at terminal pin 4 (Reset) reaches the threshold of 0.4 volts minimum. The timer will operate at supply voltages down to 2 volts, ensuring a safe margin over the minimum required battery voltage.
Capacitor C1 charges through the timing resistors R1 and R5 with a time constant such that the timer is activated for a nominal one second before the flow of current through this R-C chain drops the voltage at the junction of R1 and R5 below the Reset threshold voltage and the astable circuit ceases oscillating.
The oscillation frequency is set by resistor R6 (680 k ohm) and capacitor C3 (0.1 microfarad) in accordance with the equation

$$F = \frac{1}{1.4 * R 6 * C 3} ;$$

10.5 Hz.
TR4 is a bipolar transistor configured as a switch, and provides drive current to the relay driver transistor TR1. Both of these transistors are held in the “Off” state until IC1 commences to oscillate, thus minimising overall circuit current drain. When switched on, TR1 will drop approximately 0.2 volts of the available supply, thus minimising the drive losses. An alternative output stage present in versions normally deriving power from a mains supply is used in the circuit shown in FIG. 4. Here, a more lossy MOSFET output stage is used, saving several discreet components.
Diode D1 ensures that the reverse voltage fed back by the striker plate coil switching off is clamped to a safe level. A similar diode is built in to the 2N7000 MOSFET to meet this requirement if the MOSFET driver is used.
All electronic components are rated for a minimum of 15 volts over the specified operating temperature range.

Low Voltage Alert

Further components shown in the circuit diagram of FIG. 4 are dedicated to the role of alerting the user to the need for replacing the non-rechargeable batteries. The circuit is designed to consume minimal system current, in accordance with the following description:
Transistor TR5 is configured as a switch, which is normally in the “off” condition while the battery voltage it monitors at the Base remains above the desired low voltage threshold set by zener diode ZD1 (nominally 5.6 volts). This threshold is set by the voltage divider effect of R9, VR1 and R10, and will need to be individually adjusted in production to trigger at a battery level of 9 volts by variable resistor VR1. Note that the emitter voltage of TR5 will be somewhat lower than the nominal zener diode voltage due to operation at a current level well below the optimum regulation level.
While TR5 remains off, TR6 also remains switched off, and the only nonleakage current flowing is through the low voltage alert LED1 flows through R11+R9+VR1+R10. This current may be sufficient to slightly illuminate some high sensitivity LED types.
As battery voltage drops, the voltage at the base of TR5 eventually reduces below the zener diode voltage maintained at the emitter. Once this voltage drops to the zener voltage less the nominal base-emitter threshold voltage(approximately 0.7 volts), TR5 switches to the on state, and applies a current pulse to the base of TR6 using the charge stored on Capacitor C4. The low voltage alert LED pulses on for a short time, set by the charge available on C4.
Once C4 discharges, TR6 turns off (and hence the LED ceases to illuminate). C4 must then recharge via R8 before the cycle repeats. The cycle repeats continuously until either the batteries are replaced, or all battery energy is consumed.

Instantaneous Electric Door Release

One embodiment of the electric strike will now be described. Two preferred forms of the electric strike are basic DORCAS MODEL Aa and surface mounting model DORCAS MODEL DOR215.

The DORCAS MODEL Aa instantaneous electric door release is the basic model used. For doors opening outward, such as security screen doors, this can be employed either directly, or with guide plate that enhances the aesthetics of the installation.

For inward opening doors, the door release uses a surface mounted housing that attaches directly to the door frame.

These electric door releases are both nominally 12 volt models. Testing has revealed reliable operation down to 8 volts. Coil current is nominally 350 mA at 12 volt operation.

The instantaneous model door release may employ a pin in a rotating mechanism that senses when the deadlock strike is engaged. Without current applied, the rotating release mechanism is held in the locked position. When a short current pulse is applied, the sense mechanism allows a lever to be released, which allows the rotating mechanism that is engaged with the door strike to rotate when an opening force is applied through the lock strike via the attached door, and the door can be opened. The rotating mechanism then re-engages in the inactive position, preventing the security door's strike from returning to the locked position until the deadlock mechanism is unlocked.

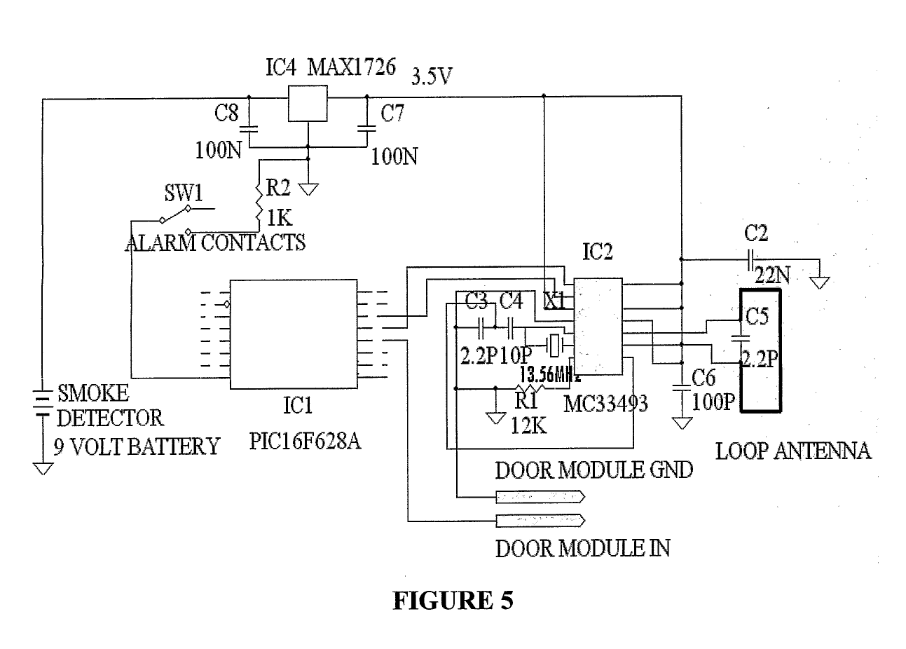

One modification of the safety system of the present invention is shown in FIG. 5.

Shown in FIG. 5 is an alternative embodiment of the present invention whereby the transmitting circuit for producing a detection signal, as shown in FIG. 2, has had the discrete analogue components replaced with microcontrollers. Shown in FIG. 5 is IC1, a PIC16F628 FLASH based 8-bit CMOS Microcontroller with interrupt capability. The external interrupt port RB0INT of IC1 is used to activate the microcontroller from SLEEP, or inactive, mode to active mode in the event of smoke being detected and the smoke alarm switch SW1 being activated. The activation of the smoke alarm switch directs current from the smoke detector battery, typically 9V, through a voltage regulator IC4, into the microcontroller IC1.

The regulator IC4 is a MAX1726 low drop out linear regulator, used for ultra low power consuming applications requiring consistent current flow and long battery life. IC4 maintains a current of 2 μA throughout its entire operating range, including drop out situations, and outputs 3.5V to IC2.

IC2 is a MC33494 RF transmitter used for UHF data transmission and its data input is an output of IC1 giving the status of the smoke alarm. A code word is transmitted by IC2 to a receiving door circuit, using a loop antenna, in a similar fashion to FIG. 2. Also outputted from IC2 and IC1 is signalling information as a checking mechanism and to safeguard against transmission failure. Signals Door Module Hi and Door Module Lo are outputted to ensure that the deadlock bolt is free of the striker plate in the event of a smoke alarm and that the striker plate remains in its normal position during normal operation.

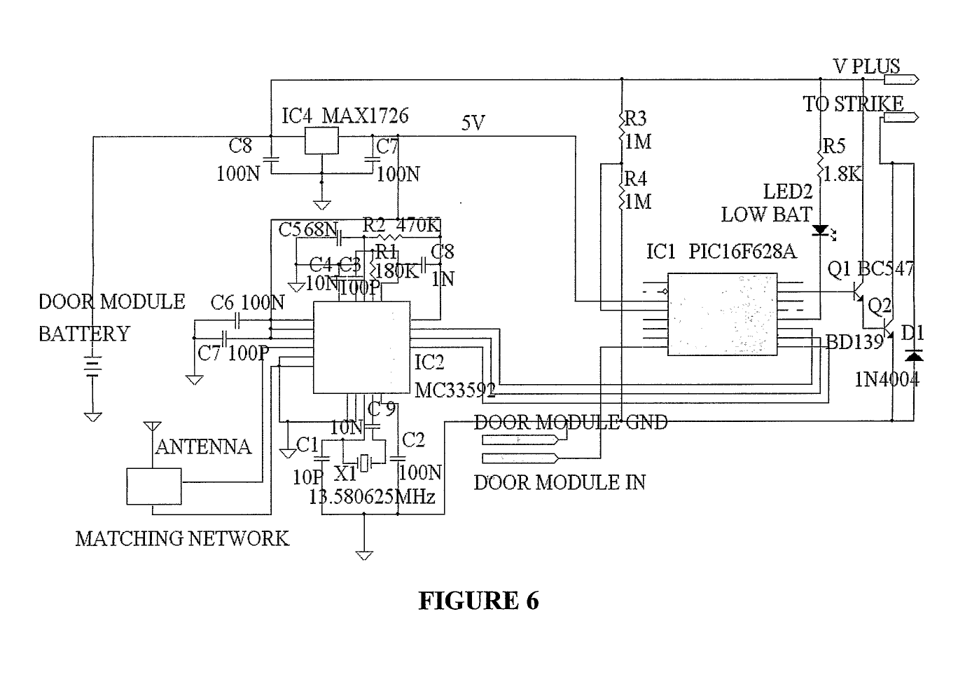

Another modification of the safety system of the present invention is shown in FIG. 6. Shown in FIG. 6 is an alternative embodiment of the present invention whereby the receiver for receiving a detection signal, as shown in FIG. 3, has had the discrete analogue components replaced with microcontrollers. Shown in FIG. 6 is IC2, a MC33592 RF receiver, used to receive the transmitted code word from the transmitter circuit. IC2 has the ability to be operated in SLEEP mode, for very low power consumption, and is periodically woken up using a strobe oscillator and variable resistor—capacitor RC values. In the embodiment shown in FIG. 6, IC2 is activated by receiving the code word transmitted from the transmitter circuit.

Outputted from IC2 is a master clock, used to synchronise data movement both in and out of IC2, and master and slave outputs. The master and slave outputs are capable of exchanging a byte of information during a sequence of eight clock cycles and transmit information regarding the status of the smoke alarm to IC1.

IC 1 is a PIC16F628 FLASH based 8-bit CMOS Microcontroller with interrupt capability and outputs a signal reflecting the status of the smoke alarm to the striker plate coil. In the event that the transmitting circuit transmits that a smoke alarm has occurred, a Strike Hi signal is outputted to the striker plate. The striker plate then receives 12V from the door module battery pack, bypassing voltage regulator IC4, and moves to release the door from its deadlock bolt. IC4 is a MAX1726 low drop out linear regulator ensuring that 5V is received by IC1 and IC2. If no smoke alarm signal is received, a Strike Lo signal is sent to the striker plate maintaining the striker plate in the closed position.

The transmitting and receiving circuits provide a checking mechanism to ensure the door is able to be opened when a smoke alarm has been activated. A Door Module Hi signal from the transmitter circuit is received as an external interrupt by IC1 to activate IC1 from its SLEEP mode and power the movement of the striker plate. Otherwise, a Door Module Lo signal is sent to the striker plate to ensure that the striker plate is not activated inadvertently opening the door.

### ADVANTAGES OF THE PRESENT INVENTION

One advantage of the safety system of the present invention is the combination of the smoke sensing ability of the smoke detector with an electrically opened striker plate release allows a deadlocked door to be automatically released in the event of smoke being sensed by the detector. This combination eliminates the need for occupants to search for the misplaced security door or main door keys in the high stress situation of a house fire.

Another advantage of the present invention is that even if power to the electric door lock is interrupted, the normally closed electrically operated strike plate locking mechanism can be released using the internal battery of the battery operated smoke detector's or from an interconnection through an alarm panel. There is no need to replace existing door latches, as only the striker plate needs to be changed to the electrically released version.

Another advantage of the present invention is that the operating condition of the system can be tested by a simple extension to the standard testing regime of the smoke detector which is to operate the alarm test button then push or pull on the security door in the normal direction of opening the door to verify that the locking mechanism within the striker plate has released.

Another advantage of the present invention is that the safety system being battery operated is not subject to failure in an electrical fire which may trip household circuity breakers and remove power from smoke alarms in which the backup battery state may be unknown. The detector/transmitter of the present invention broadcast is coded signal to the receiver/switch, also battery powered, which in turn releases and overrides the deadlock, allowing occupants a safety exit of the burning building.

It is to be understood that, if any prior art publication is referred to herein, such reference does not constitute an admission that the publication forms a part of the common general knowledge in the art, in Australia or any other country.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A safety system capable of being used to release a barrier to allowing operation of the barrier in the event of an abnormal condition occurring, said safety system characterised in that the safety system comprises a detector for detecting the abnormal event including a sensor for detecting the occurrence of the abnormal event and a signal producing device for generating a detection signal when the abnormal event is sensed, and a control unit, for receiving the detection signal from the detector and conveying an operational signal to a release sub-assembly for releasing the barrier such that in operation, the operational signal from the control unit activates the release sub-assembly to release the barrier thereby allowing the barrier to be operated wherein the release sub-assembly includes an electrically operated striker plate assembly or component for disengaging from the barrier thereby allowing operation of the barrier and wherein the striker plate assembly or component remains in the release condition after release thereby allowing the barrier to be maintained in the operating condition whether powered or unpowered until intentionally reset.

2. A method of releasing a barrier in response to the detection of an abnormal event to release the barrier characterised in that the method includes the steps of generating a detection signal from an abnormal condition detector having a sensor for detecting the abnormal event, forwarding the detection signal to a control unit, forwarding an operational signal from the control unit to a release sub-assembly for releasing the barrier, such that the barrier is released in response to the detection of the abnormal event by the abnormal condition detector thereby allowing the barrier to be released wherein the release sub-assembly includes an electrically operated striker plate assembly or component for disengaging from the barrier and wherein the striker plate assembly or component remains in the release condition after release thereby allowing the barrier to remain in the released position allowing operation of the barrier whether powered or unpowered until intentionally reset.

3. A safety system capable of releasing a locked barrier allowing the barrier to open in the event of a fire or other abnormal event occurring, said safety system characterised in that the safety system includes a fire and/or smoke detector including a sensor for detecting heat and/or smoke and a signal producing device for producing a detection signal in accordance with the sensing of the fire and/or smoke by the detector, a control unit for receiving a detection signal and producing an operational signal for forwarding to the release sub-assembly for releasing the barrier such that when the fire and/or smoke occurs, the detector senses the occurrence of the fire and/or smoke and generates the detection signal in response to which the control unit is activated to forward the operation signal to energise the barrier release sub-assembly to open the barrier thereby allowing occupants of a building to which the system is located to escape from the building through the open barrier wherein the release sub-assembly includes an electrically operated striker plate assembly or component from disengaging from the barrier and wherein the striker plate assembly or component remains in the release condition after release thereby allowing the barrier to remain open allowing passage through or past the door whether powered or unpowered until intentionally reset.

4. The safety system of claim 1, wherein the safety system includes a door module containing a radio frequency receiver having a current consumption of at most 300 microampere.

5. The safety system of claim 1, wherein the detector is a smoke detector including a mains powered smoke detector, a battery operated smoke detector, a smoke detector having an inbuilt power source, or a smoke detector relying on an external power source.

6. The safety system of claim 1, further comprising, a single detector or two or more detectors arranged such that if there are two or more detectors, the detectors are interconnected together, networked or arranged in groups or arrays.

7. The safety system of claim 5, wherein the smoke detector is provided with an alarm wherein the smoke detector or alarm is provided with an undervoltage detection device for use with non-mains powered versions of the smoke detector to provide an indication, such as a visual indication, of the low voltage state of the battery.

8. The safety system of claim 5, wherein the smoke detector is provided with a transmitter for transmitting a coded radio signal.

9. The safety system of claim 8, wherein the transmitter transmits a digital code in which a digital code broadcast by the smoke detector persists for about fifteen seconds for each activation, preferably repeating the digital code about at least three times per second.

10. The safety system of claim 1, wherein the safety system includes a receiver for receiving the detection signal transmitted or produced by the abnormal condition detector in which the receiver is electrically connected to the control unit to relay the detection signal to the control unit in which the detector is hard wired or electrically connected to the control unit or to the receiver or the detector is provided with a transmitter for producing a wireless transmission for being received by the receiver.

11. The safety system of claim 1, wherein the detector transmits either using a hard wired electrical connection or using a transmitted signal, including a radio frequency signal, to a security panel which in turn transmits either by being electrically connected or through a radio frequency transmission to the release module or sub-assembly to release the barrier.

12. The safety system of claim 5, wherein the barrier is a door, gate, window, or other security barrier, preferably a hinged barrier, door, gate, window or the like.

13. The safety system of claim 11, wherein the security panel is the control unit or is used in association with the control unit.

14. The safety system of claim 5, wherein the control unit is a switching arrangement connected to the barrier release sub-assembly in which the control unit produces an operation signal.

15. The safety system of claim 5, wherein the detection signal and/or operation signal forwarded to the release sub-assembly is continuous, intermittent, periodic, pulsed, sequential, arranged in bursts, including multiple bursts, repeatable multiple bursts or similar.

16. The safety system of claim 1, wherein the output of the operational signal provides at least about 10 pulses at a nominal 10 Hz pulse repetition rate.

17. The safety system of claim 1, wherein the barrier is provided with a deadlock, key pad operated lock, a combination lock or similar.

18. The safety system of claim 1, wherein the barrier is provided with a lock for releasably locking the barrier and wherein the lock is a double cylinder deadlock type lock which can be deadlocked selectively from either side of the barrier.

19. The safety system of claim 1, wherein the release sub-assembly is an electric door release including an instantaneous electric door release which instantaneously moves to a release position to unlock the barrier allowing the barrier to open when the sub-assembly receives a corresponding signal from the control unit.

20. The safety system of claim 1 wherein the release sub-assembly or release mechanism is an electric door release, including an electronically operated door striker plate or door strike.

21. The safety system of claim 18, wherein the electronically operated striker plate assembly pivots about a longitudinal axis to release the barrier whilst the deadbolt of the deadlock remains in the extended position.

22. The safety system of claim 18, wherein the safety system automatically operates to release the deadlock by moving the electrically operated strike plate assembly from a locked or secured position to a released position thereby releasing the barrier for movement away from a barrier frame in the event that the detector enters an alarm state by sensing the presence of smoke and/or heat.

23. The safety system of claim 1, wherein the barrier release moves to a release state when a momentary pulse of specified current at or above a specified minimum voltage is applied or directed to the electrically operable release striker plate assembly to open the barrier.

24. The safety system of claim 1, wherein the release sub-assembly reliably operates down to 8.5 v minimum voltage and the low voltage warning threshold is 9.5 v.

25. The safety system of claim 22, wherein after a period of time, an electric door release, including the electrically operated striker plate assembly, returns to a “latched” or locked state after the lock or bolt of the door is disengaged from the door release mechanism so as to prevent the door relocking during the abnormal event and inadvertently trapping other occupants by remaining in the locked condition.

26. The safety system of claim 1, wherein after the electrically operated striker plate assembly is released by a single pulse or burst of pulses of energy, the released striker plate assembly remains in the release position and does not reset to a locked or secured condition thereby allowing the barrier to remain in an opened position.

27. The safety system of claim 1, wherein after release, the electrically operated striker plate assembly remains in the release position even when all power is interrupted including battery power or mains power.

28. The safety system of claim 1, wherein after the electrically operated striker plate assembly is released, the electrically operated striker plate assembly remains in the released position until after the barrier is opened.

29. The safety system of claim 1, wherein after release, the electrically operated striker plate assembly returns to a locked or secured position after opening of the barrier thereby preventing the barrier from being resecured and thus maintaining the barrier in the opened position.

30. The safety system of claim 1, wherein the electrically operated striker plate assembly releases the barrier while a deadbolt of a double cylinder deadlock remains in a locked and/or extended position.

31. The safety system of claim 1, wherein the control unit includes micro controllers, preferably a microchip PIC (a peripheral interface controller) which consumes very low current.

32. The safety system of claim 31, wherein an anti-spoofing code in incorporated in the PIC micro controller controlling the receiver for detecting attempts to gain unauthorised entry to a building protected by the security system by determining a security coding system that could otherwise result in the barrier being released in an unauthorised manner causing a security breach to the building.

33. The safety system of claim 1, further comprises a switch, wherein the switch is an electronic switch in electric connection to the electrically operated striker plate assembly of the release sub-assembly wherein the switch is an anti STICTION switch which is an anti-stick switch to overcome binding force of friction between sliding or moving parts between the electrically operated striker plate assembly forming the release sub-assembly.

34. The safety system of claim 1, wherein the pulsing of the signal sent to the release sub-assembly overcomes a binding force of friction to release the barrier.

35-36. (canceled)
